(19) United States
(12) Patent Application Publication
(10) Pub. No.: US 2025/0346516 A1
(43) Pub. Date: Nov. 13, 2025

(54) DEVICE FOR IN-SITU SLUDGE SOLIDIFICATION AND COMPREHENSIVE SOLIDIFICATION METHOD

(71) Applicants: Zhejiang University of Science and Technology, Hangzhou (CN); Zhejiang University, Hangzhou (CN)

(72) Inventors: Jianfeng ZHU, Hangzhou (CN); Hao YANG, Hangzhou (CN); Riqing XU, Hangzhou (CN); Yiyi ZHENG, Hangzhou (CN); Luying JU, Hangzhou (CN)

(21) Appl. No.: 19/287,719

(22) Filed: Jul. 31, 2025

(51) Int. Cl. C02F 11/00; C02F 103/00

(52) U.S. Cl. CPC C02F 11/008; C02F 2103/007; C02F 2209/00

(57) ABSTRACT

The invention discloses a device for in-situ sludge solidification and a comprehensive solidification method, which include a main control transmission chamber, an upward floating drive-curing device, a deep bi-directional cutting and curing device, a control end, external grouting pipe, a grouting source, and a slurry pump. The solidification device is characterized by high efficiency and the fact that it does not require additional equipment or methods. The solidification method enables various forms of deep, shallow, and combined deep-shallow in-situ solidification based on the field conditions of the sludge. This device and method address several issues with existing in-situ sludge solidification technologies, which are typically limited to shallow solidification, struggle to independently support deep and thick sludge areas after solidification, exhibit low efficiency, uneven solidification, and often require the use of additional equipment and processes. This invention allows for rapid and efficient large-area in-situ solidification of sludge.

### TECHNICAL FIELD

This application relates to in-situ curing of silt, and more particularly to a silt in-situ curing apparatus and an integral curing method.

### BACKGROUND

In-situ sludge stabilization technology involves the direct on-site mixing of stabilizers with sludge from lakes, rivers, ports, ponds, and tidal flats to transform it into stable, solidified soil. This method eliminates the need for separate sludge disposal sites and avoids the excavation and replacement of pond bottoms, thereby providing significant ecological and environmental benefits. In-situ curing technology for silt has received a lot of attention, however, at present, in-situ consolidation equipment is mainly based on excavators with some modifications. This equipment features a mixing head mounted on an excavator, equipped with a slurry spraying device that dispenses stabilizers during the mixing process to facilitate sludge solidification. However, the current technology requires manual operation of the mixing head's vertical movement when inserted into the sludge, resulting in variable depths and angles of insertion that complicate achieving comprehensive coverage of the stabilization area. Moreover, the single slurry injection port on the mixing head restricts the mixing and injection duration at various depths, leading to insufficient solidification and uneven depth coverage. Additionally, each new phase of sludge stabilization necessitates the placement of metal plates to increase the contact area and prevent the excavator from sinking. Expanding the stabilization area involves repositioning these plates, which reduces efficiency. Consequently, this technology is appropriate for small-scale, localized sludge stabilization. When applied to larger sludge areas, it leads to extended project durations, uneven solidification, decreased load-bearing capacity of the stabilized area, and potential uneven settlement after project completion.

Furthermore, due to the limitations of the excavator's arm length and the cutting capability of the mixing head, the equipment can only achieve shallow stabilization in sludge with a depth of less than 3 meters. This constraint means that existing in-situ stabilization technology is limited to creating a shallow stabilized layer, making it ineffective for deeper sludge conditions. Consequently, additional stabilization processes are necessary to meet engineering requirements. The most commonly used method involves initially forming a hard shell layer through in-situ stabilization, followed by transporting piling equipment to the site. This approach requires two separate construction phases and necessitates waiting for the hard shell layer to gain sufficient strength before proceeding with piling. As a result, project durations are extended, and efficiency is reduced, with the pre-formed hard shell layer often sustaining significant damage during the piling process, which impedes effective load-bearing integration. Consequently, the hard shell layer primarily serves as a temporary platform for piling in deep sludge areas, while the piling process addresses the deeper sludge. However, because the piles are independently load-bearing, vertical loads on the sludge can lead to instability and failure of some piles due to lateral shear forces. Additionally, when using this equipment for large-scale sludge stabilization in lakes, ports, or tidal flats, the excavator cannot maneuver freely on the sludge. Therefore, the equipment is designed for incremental stabilization from shore to offshore: starting with stabilization at the shore, allowing the sludge to gain sufficient strength over time, and then progressing to further stabilization phases as piling equipment becomes available. This incremental approach results in prolonged project timelines and significantly affects the speed of in-situ sludge stabilization construction.

Therefore, these deficiencies considerably impede the broad implementation of in-situ sludge stabilization technology in construction projects.

### SUMMARY

The present invention addresses several significant technical challenges associated with current in-situ sludge stabilization technologies. These challenges include inefficient operation, inconsistent and unpredictable solidification, limited depth of stabilization, and difficulties in independently and effectively stabilizing deep sludge areas. To overcome these challenges, the invention introduces a novel in-situ sludge stabilization device and an integrated stabilization method, both designed to enhance operational efficiency, ensure uniform solidification, and facilitate independent operation.

Compared to the prior art, the present disclosure has the following beneficial effects.

1. The invention achieves comprehensive in-situ sludge stabilization. The deep vertical stabilization body, formed by the deep bi-directional cutting and curing device, and the shallow horizontal stabilization body, formed by the upward floating drive-curing device, are constructed and formed simultaneously. This process results in a three-dimensional stabilized soil load-bearing layer that effectively resists vertical loads and the pressure exerted by the surrounding sludge. Consequently, this ensures the integrity and uniformity of the stabilized sludge.

2. Wide Applicability: The invention is adaptable, enabling the creation of shallow horizontal and deep vertical stabilization bodies in various shapes tailored to specific conditions. In load-concentrated areas, horizontal stabilization density can be increased, while vertical depth can be adjusted. In areas with significant lateral sludge pressure, vertical surface area can be expanded, including the formation of wall-like structures to resist lateral pressure.

3. The solidification range is extensive and uniform. The deep bi-directional cutting and curing device described in this invention is equipped with multiple grouting points distributed along its height, ensuring that sufficient solidifying agent reaches the silt at various depths. The cutting keel is designed for full-depth longitudinal cutting and stirring of the silt, while silt stirrers placed at half-meter intervals along the depth perform horizontal cutting and stirring. The device moves vertically at a constant speed through a motorized spur hexagonal gear assembly, and the first and second vertical rotating components can adjust the rotation direction, ensuring thorough mixing and solidification of the silt throughout its depth, thereby guaranteeing uniform solidification along the entire depth.

4. The solidification efficiency is high. This invention enables continuous mixing and solidification of the silt, eliminating the need to wait for the solidified silt to gain strength or for the transportation and installation of iron plates. As a result, construction time is significantly reduced.

5. The purely mechanical operation eliminates the risks of uncontrollable solidification effects associated with manual handling.

6. The solidification depth can be enhanced by extending the length of the deep bi-directional cutting and curing device, allowing for deeper solidification.

7. The system is highly automated, allowing a single operator to manage multiple devices from the control end. It provides real-time updates on device status and ensures efficient, intelligent solidification by enabling the input of relevant instructions based on the received information.

### BRIEF DESCRIPTION OF THE DRAWINGS

FIG. 1 is a schematic diagram of the silt in-situ solidification equipment structure according to an embodiment of the present invention;

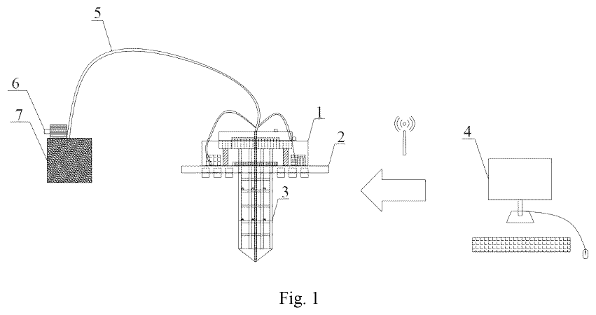

FIG. 2 is a schematic diagram of the main control transmission chamber structure provided by an embodiment of the present invention;

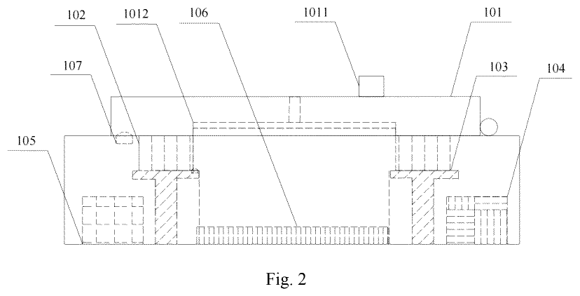

FIG. 3 is a schematic diagram of the upward floating drive-curing device according to an embodiment of the present invention;

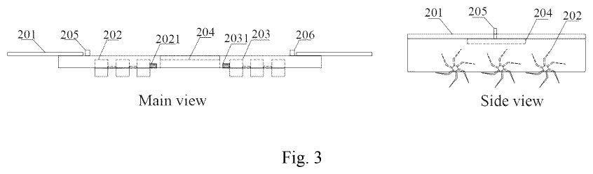

FIG. 4 is a schematic diagram of the deep bi-directional cutting and curing device structure provided by an embodiment of the present invention;

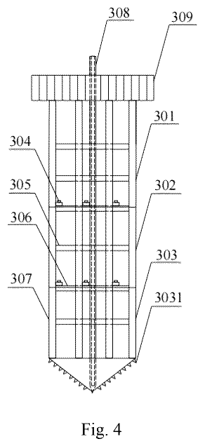

FIG. 5 is a schematic diagram of the intelligent top cover according to an embodiment of the present invention;

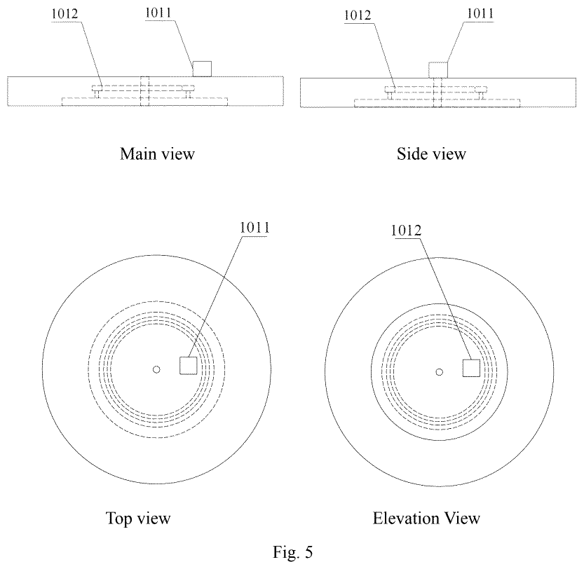

FIG. 6 is a schematic diagram of the free-rotating wall-adhering device structure provided by an embodiment of the present invention;

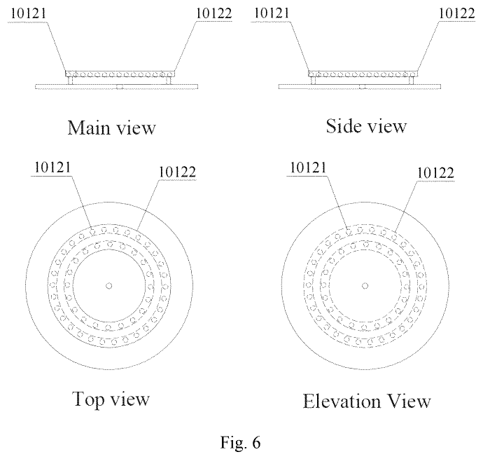

FIG. 7 is a schematic diagram of the vertical rotation assembly No. 1 structure according to an embodiment of the present invention;

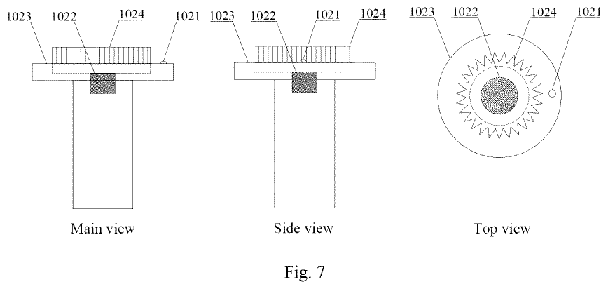

FIG. 8 is a schematic diagram of the vertical rotation assembly No. 1 structure provided by an embodiment of the present invention;

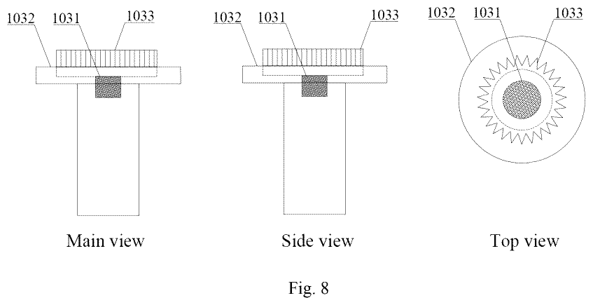

FIG. 9 is a schematic diagram of the grouting pipe structure according to an embodiment of the present invention;

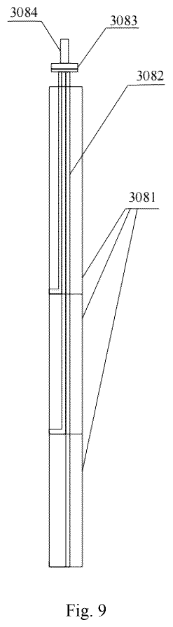

FIG. 10 is a schematic diagram of the fixed segment of deep bi-directional cutting and curing device provided by an embodiment of the present invention;

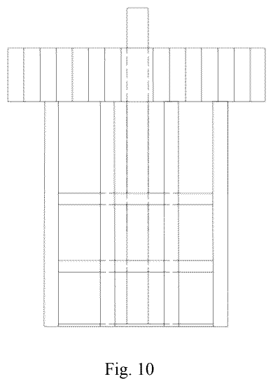

FIG. 11 is a schematic diagram of the extension segment of deep bi-directional cutting and curing device according to an embodiment of the present invention;

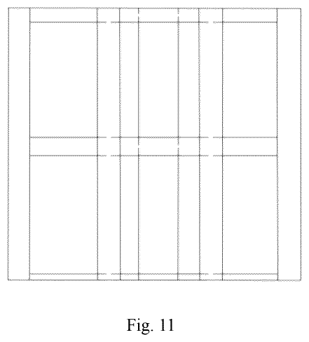

FIG. 12 is a schematic diagram of the head segment of deep bi-directional cutting and curing device provided by an embodiment of the present invention;

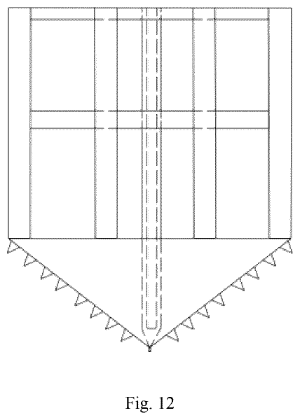

FIG. 13 is a schematic diagram of the slurry mixer structure according to an embodiment of the present invention;

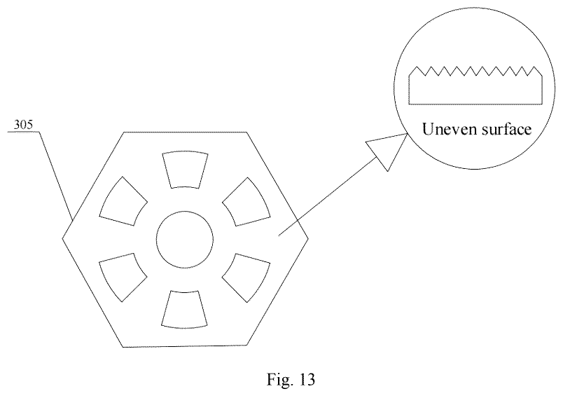

FIG. 14 is a schematic diagram of the motorized spur hexagonal gear assembly structure provided by an embodiment of the present invention;

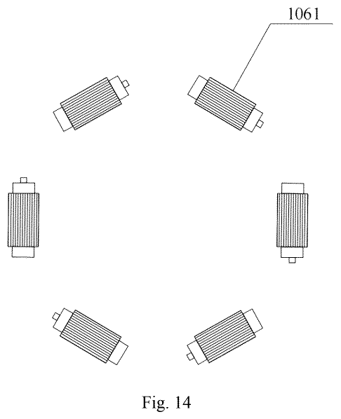

FIG. 15 is a schematic diagram of the sub-gear structure according to an embodiment of the present invention; and

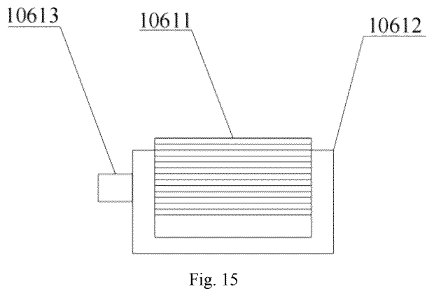

FIG. 16 is a schematic diagram of the three-dimensional solidification body load-bearing structure provided by an embodiment of the present invention.

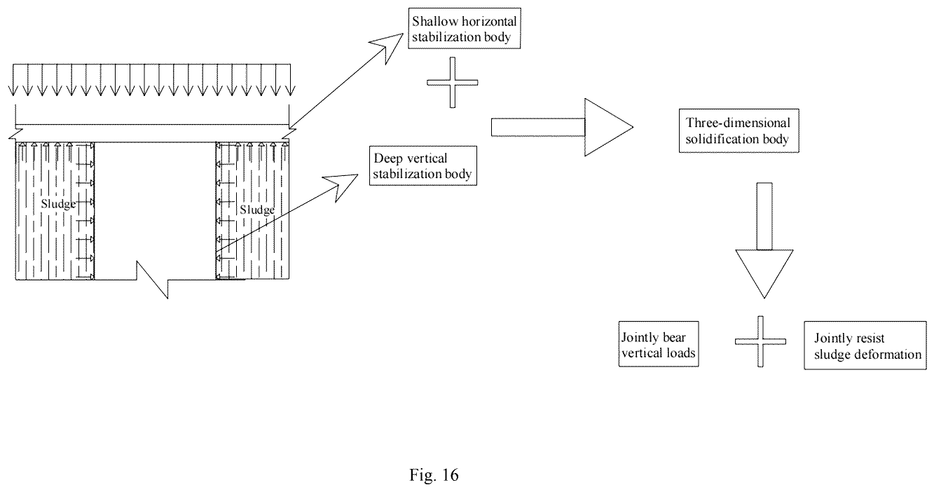

In the figures: 1—main control transmission chamber; 2—upward floating drive-curing device; 3—deep bi-directional cutting and curing device; 4—control end; 5—external grouting pipe; 6—grouting source; 7—slurry pump; 101—intelligent top cover; 102—vertical rotation assembly No. 1; 103—vertical rotation assembly No. 2; 104—sensor data collection system; 105—main control system; 106—motorized spur hexagonal gear assembly; 107—control switch for deep bi-directional cutting and curing device; 201—extendable floating plate; 202—independent stirring forward wheel No. 1; 203—independent stirring forward wheel No. 2; 204—mud removal brush; 205—grouting port No. 1; 206—grouting port No. 2; 301—fixed segment of deep bi-directional cutting and curing device; 302—extension segment of deep bi-directional cutting and curing device; 303—head segment of deep bi-directional cutting and curing device; 304—high-strength connecting bolt; 305—slurry mixer; 306—segmental connecting base plate; 307—cutting keel; 308—grouting pipe; 309—self-rotating gear for deep bi-directional cutting and curing device; 1011—gps positioning device; 1012—free-rotating wall-adhering device; 1021—cover opening/closing switch; 1022—electric rotator No. 1; 1023—support base No. 1; 1024—gear No. 1; 1031—electric rotator No. 2; 1032—support base No. 2; 1033—gear No. 2; 1061—sub-gear; 2021—independent motor No. 1; 2031—independent motor No. 2; 3031—stirring drill bit; 3081—segmental outer shell; 3082—branch pipe; 3083—diverting rotating connector; 3084—main pipe; 10121—rotating bead; 10122—embedded sliding strip; 10611—sub-gear component; 10612—sub-gear base; and 10613—sub-gear rotating motor.

### DETAILED DESCRIPTION OF EMBODIMENTS

The equipment is first transported to the target area requiring solidification. The deep bi-directional cutting and curing device 3 is assembled based on the required curing depth. From top to bottom, the assembly includes the fixed segment of deep bi-directional cutting and curing device 301 at the top, the extension segment of deep bi-directional cutting and curing device 302 in the middle, and the head segment of deep bi-directional cutting and curing device 303 at the bottom. Each additional extension segment of deep bi-directional cutting and curing device 302 increases the curing depth by 1 meter.

Upon completion of the assembly, the deep bi-directional cutting and curing device 3 is installed at the central position of the upward floating drive-curing device 2. The operator at the control end 4 adjusts the position so that the lateral surfaces of the six cutting keels 307 are meshed with the respective gears of the motorized spur hexagonal gear assembly 106. The operator then inputs a downward movement command at the control end 4, causing the deep bi-directional cutting and curing device 3 to be driven downward into the sludge to a predetermined depth by gear transmission.

The control end 4 also allows the operator to control the traveling direction of the upward floating drive-curing device 2. To steer the equipment to one side, the operator slows down or halts the independent stirring forward wheel on that side (either independent stirring forward wheel No. 1 202 or independent stirring forward wheel No. 2 203), while accelerating the opposite wheel. Once the turning is complete, the speeds of both wheels are adjusted to match, allowing the equipment to proceed in a straight line.

To prevent sinking, the area of the extendable floating plate 201 is adjusted based on the equipment's own weight.

During operation, the deep bi-directional cutting and curing device 3 performs rotational cutting and grouting. The grouting source 6 may be implemented in two forms: if the required amount of curing agent is relatively small and the equipment's buoyancy can support the load, the grouting source 6 may be mounted directly on the equipment; otherwise, it may be located externally and connected via the external grouting pipe 5.

The stirring direction of the deep bi-directional cutting and curing device 3 can be altered by simultaneously changing the rotational directions of both the vertical rotation assembly No. 1 102 and the vertical rotation assembly No. 2 103, thereby enhancing the mixing of sludge and curing agent. This process continues until the curing operation is completed.

If non-uniform sludge thickness is detected in localized regions during the curing process, the curing depth can be adjusted either by adding or removing segments of the deep bi-directional cutting and curing device 3, or by reversing the rotation direction of the motorized spur hexagonal gear assembly 106.

This curing method utilizes a combined deep and shallow curing approach to achieve integrated sludge solidification. The vertically-formed deep cured body, resulting from deep curing, and the shallow cured body, formed by shallow curing, together construct a three-dimensional solidified structure that jointly bears external loads.

The deep cured body may take the form of vertical strip-shaped structures or wall-shaped bodies with varying side profiles, controllable via the lifting and advancing operations of the deep bi-directional cutting and curing device 3 by the operator at the control end 4.

The shallow cured body may either be a continuous hard shell layer over the entire surface or a series of transversely aligned strip-shaped cured sections formed end-to-end. These are realized by setting specific travel paths for the upward floating drive-curing device 2 under the control of the operator.

Additionally, in regions where the sludge is particularly weak, localized reinforcement can be achieved by increasing the depth of the deep cured body, raising the quantity of curing agent, or expanding the radial coverage of the deep cured body.

What is claimed is:

1. An in-situ sludge solidification device, comprising:
a main control transmission chamber;
an upward floating drive-curing device;
a deep bi-directional cutting and curing device;
a control end;
external grouting pipes;
a grouting source; and
a slurry pump;
wherein the main control transmission chamber is located at the top of the device, receives signals, relays instructions, and controls both the upward floating drive-curing device and the deep bi-directional cutting and curing device;
positioned below the main control transmission chamber, the upward floating drive-curing device performs surface layer solidification and manages the device's movement and steering;
the deep bi-directional cutting and curing device is located at the bottom of the device and extend vertically through the main control transmission chamber and the upward floating drive-curing device; and its top end can be fixed inside the main control transmission chamber, allowing for bidirectional cutting and solidification of deep sludge;
each segment of the deep bi-directional cutting and curing device is 1 meter long;
the control end enables operators to send signals from an indoor location to control the device and receive operational information;
the external grouting pipes connect the grouting port of the solidification device to the grouting source, delivering the slurry into the device;
the grouting source provides the slurry is then pumped by the slurry pump to the designated positions within the solidification device;
the main control transmission chamber includes an intelligent top cover, a vertical rotation assembly No. 1, a vertical rotation assembly No. 2, a sensor data collection system, a main control system, a motorized spur hexagonal gear assembly, and a control switch for deep bi-directional cutting and curing device;
the upward floating drive-curing device features an extendable floating plate, an independent stirring forward wheel No. 1, an independent stirring forward wheel No. 2, a mud removal brush, and two grouting ports;
the deep bi-directional cutting and curing device comprises a fixed segment, an extension segment, a head segment, high-strength connecting bolt, a slurry mixer, a segmental connecting base plate, a cutting keel, grouting pipes, and a self-rotating gear;
the fixed segment of the deep bi-directional cutting and curing device, located at its upper end;
the self-rotating gear of this device is securely attached to the top of the fixed segment; and the protruding sides of the self-rotating gear rest on the support base No. 1 and the support base No. 2, ensuring that the deep bi-directional cutting and curing device remains firmly fixed within the main control transmission chamber;
the extension segment of the deep bi-directional cutting and curing device constitutes the middle portion of the device;
the overall length of the deep bi-directional cutting and curing device can be adjusted by increasing or decreasing the number of these extension segments, thus altering the maximum depth of curing;
the head segment of the deep bi-directional cutting and curing device is situated at the bottom end of the device;
the lowest portion of this segment features a stirring drill, which can have various configurations, with a conical shape being predominant; and
this conical design helps to reduce the insertion resistance of the deep bi-directional cutting and curing device into the soil.

2. The in-situ sludge solidification device according to claim 1, wherein its intelligent top cover, which incorporates a GPS positioning device and a free-rotating wall-adhering device;
the intelligent top cover features a central hole through which the grouting pipe extends to connect with the external grouting pipes;
an elastic sealing ring surrounds the hole to prevent any collision between the grouting pipe and the hole;
the GPS positioning device, positioned at the top of the intelligent top cover, transmits information including the device's location, forward direction, and speed to the control terminal, allowing operators to monitor the device's status in real time;
the free-rotating wall-adhering device, located at the bottom of the top cover, rotates around its center; and
when the intelligent top cover is closed, its bottom surface makes contact with the top end of the deep bi-directional cutting and curing device, thereby restricting the vertical movement of the solidification device while providing sufficient space for its self-rotation.

3. The in-situ sludge solidification device according to claim 1, wherein the free-rotating wall-adhering device, which consists of a rotating bead and a embedded sliding strip;
the mechanism's top surface features a vertical annular protrusion, with the protrusion extending horizontally inward and outward from the ring;
the underside of these protruding sections is lined with rolling balls arranged around the circumference; and
this protrusion is designed to fit into a slot at the bottom of the intelligent top cover, allowing the rolling balls to facilitate smooth and unrestricted rotation of the wall-contact mechanism.

4. The in-situ sludge solidification device according to claim 1, wherein a vertical rotation assembly No. 1 comprises a cover opening/closing switch, an electric rotator No. 1, a support base No. 1, and a gear No. 1;
the cover opening/closing switch is positioned at the edge of the support base No. 1, adjacent to the deep bi-directional cutting and curing device;
activation of the switch closes the internal circuit, causing the intelligent top cover to close;
the electric rotator No. 1 is designed to rotate the gear No. 1, which is mounted on its upper section, and positioned beneath the electric rotary drive;
the support base No. 1 has a top surface equipped with a horizontally extending load-bearing plate; and this plate supports the protruding edge of the self-rotating gear of the deep bi-directional cutting and curing device in relation to its main body;
the gear No. 1, driven by the electric rotary drive, can rotate both clockwise and counterclockwise;
when the self-rotating gear of the deep bi-directional cutting and curing device is placed on the support base No. 1, it meshes accurately with the gear No. 1;
the vertical rotation assembly No. 1 drives the deep bi-directional cutting and curing device to rotate in the opposite direction of the gear No. 1 through gear meshing connections;
the vertical rotation assembly No. 2, which is symmetrically arranged around the center of the deep bi-directional cutting and curing device in relation to the vertical rotation assembly No. 1;
this vertical rotation assembly No. 2 comprises an electric rotator No. 2, a support base No. 2, and a gear No. 2;
each component of the vertical rotation assembly No. 2 is functionally identical to its corresponding component in the vertical rotation assembly No. 1;
the gear No. 2 and the gear No. 1 rotate simultaneously in the same direction;
the simultaneous operation of the No. 1 and No. 2 vertical rotation assemblies, connected via gears, cause the deep bi-directional cutting and curing device to rotate in the opposite direction to the rotation of the first and second gears; and
the symmetrical arrangement of gears on both sides ensures that forces are evenly distributed across the deep bi-directional cutting and curing device, resulting in smooth and stable rotation.

5. The in-situ sludge solidification device according to claim 1, wherein its sensor data collection system, which receives signals from the control end, such as radio frequency and infrared signals; and
this system is tasked with decoding the signals and converting them into control instructions that the machine can interpret, the main control system, which receives instructions from the sensor data collection system and carries out the corresponding operations or actions.

6. The in-situ sludge solidification device according to claim 1, wherein the motorized spur hexagonal gear assembly, which is located around the edge of the hole at the bottom of the main control transmission chamber;
this gear set consists of six individual sub-gears arranged in a horizontal plane to form a regular hexagon, with adjacent gears connected;
each of the individual gears meshes tightly with one of the six cutting keels on the sides of the deep bi-directional cutting and curing device;
the rotation of the hexagonal electric gear set drives the cutting keels vertically, resulting in the vertical movement of the deep bi-directional cutting and curing device; and
the sub-gear component comprises a gear component, a sub-gear base, and a sub-gear rotating motor.

7. The in-situ sludge solidification device according to claim 1, wherein features extendable floating plates on either side of the upward floating drive-curing device; and
the device's buoyancy can be adjusted by changing the area of these extendable floating plates, with the extension controlled by the control terminal.

8. The in-situ sludge solidification device according to claim 1, wherein the independent stirring forward wheel No. 1 and the independent stirring forward wheel No. 2;
these wheels are located on the left and right sides (relative to the device's forward direction) of the bottom of the upward floating drive-curing device;
both wheels are designed to cut through sludge and move over it;
the stirring forward wheels are equipped with multiple curved cutting blades;
these blades are arranged with their trailing edges facing the direction of the device's movement, allowing them to cut and stir the sludge effectively as the device progresses; and
the first and second independent stirring forward wheels are each equipped with a dedicated motor (referred to as the independent motor No. 1 and independent motor No. 2, respectively); and these motors enable the wheels to operate independently for both stirring and advancing, and can be controlled via the control end.

9. The in-situ sludge solidification device according to claim 1, wherein a mud removal brush is positioned around the edge of the lower hole in the upward floating drive-curing device; and
the trailing edge of the mud removal brush makes contact with the sidewalls of the cutting keels of the deep-layer bidirectional cutting solidification device; and this arrangement allows the mud removal brush to clean the sludge carried by the deep bi-directional cutting and curing device during its ascent, ensuring a tight mesh between the cutting keels and the corresponding individual gears.

10. The in-situ sludge solidification device according to claim 1, wherein a grouting port No. 1 and a grouting port No. 2 are positioned on the left and right sides of the upward floating drive-curing device (relative to its forward direction); and
these ports are directly connected to the grouting source, enabling the injection of curing slurry into the work areas of the respective stirring wheels as the device moves forward, thus facilitating effective mixing and solidification.

11. The in-situ sludge solidification device according to claim 1, wherein a grouting port is located at the top of the stirring drill bit, which is designed to inject curing slurry;
the grouting pipe includes a segmental outer shell, branch pipes, a diverting rotating connector, and a main pipe;
the segmental outer shell that is securely attached to the central position of the slurry mixer;
each segment of the outer shell extends continuously, with a hole at the bottom of each segment to accommodate the branch pipes for grouting;
each branch pipes has an end positioned at the bottom of each segment of the deep bi-directional cutting and curing device;
these branch pipes are responsible for grouting and curing in their respective areas;
the diverting rotary connector has multiple branch pipe connection ports at one end for connecting all branch pipes and is connected to the main pipe at the other end;
the slurry inside the main pipe flows through the diversion rotary connector, allowing for proper distribution;
both ends of the diversion rotary connector can rotate freely, thereby preventing disturbances to the main pipe during the rotation of the deep bi-directional cutting and curing device; and
the main pipe connects to the diversion rotary connector at one end and to a branch pipe positioned in the middle of the external grouting pipe at the other end.

12. The in-situ sludge solidification device according to claim 1, wherein the high-strength connecting bolt that secure the fixed segment, extension segment, and head segment of the deep bi-directional cutting and curing device, connecting these components into a unified assembly from top to bottom.

13. The in-situ sludge solidification device according to claim 1, wherein the slurry mixer, which is hexagonal in shape;
during operation, the slurry mixer rotates around its axis to perform lateral cutting of the sludge;
the surface of the slurry mixer is uneven and contains numerous holes, which help reduce the insertion resistance of the deep bi-directional cutting and curing device during its descent;
as the deep bi-directional cutting and curing device rotates, the uneven surface of the slurry mixer increases friction with the sludge, enhancing the effectiveness of lateral cutting;
the holes on the surface of the slurry mixer cause some sludge to become trapped, thereby generating localized cutting that complements the overall lateral cutting effect of the slurry mixer; this combination of “overall+localized” lateral cutting within the operational range of the slurry mixer ensures thorough mixing of the sludge;
one slurry mixer is positioned at the top of each segment, and the other is placed in the middle;
each slurry mixer is equipped with six cutting keels, which are attached at the six corners of the slurry mixer and oriented perpendicular to its surface;
the cutting keels feature notches on their outer surfaces that mesh tightly with the gears of the motorized spur hexagonal gear assembly;
the rotation of these gears drives the cutting keels up or down, enabling the vertical movement of the deep bi-directional cutting and curing device;
as the device rotates, the six cutting keels spin around the center, facilitating both the longitudinal cutting and mixing of the sludge;
a central hole in the slurry mixer allows for the passage of the grouting pipe;
the segmental connecting base plate is positioned at the bottom of each segment of the deep bi-directional cutting and curing device;
these plates are iron sheets shaped to match the slurry mixers; and
high-strength connecting bolt join the segmental connecting base plate of one segment with the top of the slurry mixer in the adjacent segment, thereby forming a unified assembly.

14. The in-situ sludge solidification device according to claim 1, wherein the self-rotating gear for deep bi-directional cutting and curing device, which is located at the top of the device's fixed segment and engages with both the vertical rotation assembly No. 1 and vertical rotation assembly No. 2.

15. The in-situ sludge solidification device according to claim 1, wherein an external grouting pipe, with one end connected to the grouting source; and
the other end of this pipe has three branch pipes: the middle branch pipe connects to the main pipe, and the two outer branch pipes connect to the grouting port No. 1 and the grouting port No. 2, respectively.

16. The in-situ sludge solidification device according to claim 1, wherein the grouting source, which is a storage device for providing the slurry;
there are two forms: if the demand for the curing agent is low and the buoyancy of the solidification device can support it, the grouting source can be directly installed on the device; and
if the demand is higher, it can be placed at a location outside the sludge area.

17. An integrated in-situ sludge solidification method according to claim 1, comprising:
combine both deep-layer and shallow-layer curing techniques, tailored to specific operational conditions, to achieve comprehensive sludge solidification;
one method is by forming a vertical deep-layer solidification body, which, in conjunction with a horizontal solidification body created through shallow-layer curing, results in a three-dimensional solidification structure that collectively supports external loads;
wherein the deep-layer solidification body, which can be configured as either a vertical strip-shaped solidification body or a vertical wall-shaped solidification body with various cross-sectional profiles; this flexibility is achieved by adjusting the elevation and forward movement of the deep-layer bidirectional cutting solidification device; and the shallow-layer solidification body, which can either be a continuous hard shell layer or a shallow-layer solidification body formed by interconnecting both ends of multiple transverse strip-shaped solidification bodies, thereby forming integrated geometric frameworks such as grid-shaped or triangulated structures;
another method is reinforcing the deep-layer solidification body in weak areas of the sludge site; and
this reinforcement can be accomplished by increasing the depth of the deep-layer solidification body, augmenting the amount of curing agent applied, and expanding the radial extent of the deep-layer solidification body.

18. The integrated in-situ sludge solidification method according to claim 17, further comprising:
steering mechanism, which operates as follows: to steer the solidification device to one side, the rotation of the independent stirring forward wheel on that side is either stopped or slowed, while the independent stirring forward wheel on the opposite side is accelerated; and
after the turn is completed, the rotation speeds of both independent stirring forward wheels are adjusted and synchronized to ensure the solidification device resumes straight-line movement.

19. The integrated in-situ sludge solidification method according to claim 17, further comprising:
altering the stirring direction of the deep bi-directional cutting and curing device by simultaneously adjusting the direction of the vertical rotation assembly No. 1 and vertical rotation assembly No. 2; and this adjustment enables thorough mixing of the sludge and curing agent; and
adjusting the curing depth during the process; this adjustment can be made either by installing or removing the deep bi-directional cutting and curing device or by altering the rotation direction of the motorized spur hexagonal gear assembly.
